(19) United States
(12) Patent Application Publication
(10) Pub. No.: US 2002/0102378 A1
(43) Pub. Date: Aug. 1, 2002

(54) Duplexing ties

(76) Inventors: Timothy W. Rawlings, Waynesville, OH (US); Joseph D. Roth, Springboro, OH (US); Wayne D. Finster, Saline Co, AR (US); Mitchell R. Bauer, Lititz, PA (US)

Correspondence Address: Douglas S. Foote, NCR Corporation, 101 West Schantz, ECD-2, Dayton, OH, 45479-0001, US

(21) Appl. No.: 09/771,719

(22) Filed: Jan. 30, 2001

(51) Int. Cl. B32B 7/06

(52) U.S. Cl. 428/42.3; 428/40.1

(57) ABSTRACT

Described are label sheets of pressure sensitive labels which are useful for duplex printing applications. The labels are provided with ties to secure them in order to lessen the adverse effects of delamination and leakage of adhesive into the printer parts. They are particularly useful for avoiding these disadvantages during duplex printing which subjects the label sheet to additional manipulation and treatment, such as two heated toner fusion steps, in contrast to simplex printing. Also described are methods of duplex printing using such label sheets.

The present invention relates generally to pressure sensitive label sheets, useful for duplexing applications. The invention is particularly applicable for example, to Integrated, Fuse Form™, Dual Web or Full Sheet laser label sheets for duplex printing applications.

### BACKGROUND OF THE INVENTION

Pressure sensitive labels are commonly available in various forms. In a typical embodiment, a label sheet includes several individually removable labels which define an overlay or face sheet adhesively bonded to a release liner. The adhesive is permanently bonded to the back of the overlay, and forms a weak bond with the liner which typically has an exposed silicone surface permitting individual label removal therefrom.

The individual labels are typically defined by full perimeter die cuts which completely sever adjoining labels from their neighbors atop the continuous liner. By lifting the edge of an individual label, the label may be readily peeled away from the liner independently of adjacent labels, with the so removed label then being reattached to another surface using the same adhesive carried on the back of the label for effecting a bond therewith, which is typically permanent.

The adhesive must be suitably tailored in strength for maintaining integrity of the entire label sheet to prevent premature delamination of any of the individual labels thereon, while also permitting individual removal of the labels, with the perimeter die cuts preventing simultaneous multiple label removal.

It has been known to provide ties between adjoining labels, if it is desired to simultaneously remove two or more labels together. Several such ties may be spaced apart around the perimeter of adjoining labels so that removal of one label carries with it the so tied adjoining label in a serial strip of labels. The so removed individual labels may then be separated from each other by severing or tearing the joining ties.

It was also know to provide ties between labels used in simplex (single pass printing) applications in order to prevent delamination of labels. The problem primarily addressed there was extreme delamination, particularly of smaller labels provided with narrow feed strip caused by friction with the printer rollers (see U.S. Ser. No. 09/259,116, filed Feb. 26, 1999). The ties were thus only necessary on the smaller labels and only on the side first passing the printer roller.

In use, labels are printed for various reasons. For example, a pharmacy script is a specialized label sheet having differently sized and configured individual labels for different objectives. Relatively large labels may be used for identifying dispensed drugs and corresponding use instructions. Smaller labels may contain various warnings. And, an associated paper form integrated with the label sheet may include various information regarding the nature of the drug being dispensed and various instructions and warnings.

Pharmacy scripts are available in different configurations for various reasons. The primary objective of the pharmacy script is the labeling of prescription drug containers in a highly competitive industry. Since a typical pharmacy or drugstore dispenses a considerable volume of drug prescriptions each day, the pharmacy script must be easy and fast to use.

In one recently developed pharmacy script, several wide and narrow labels are formed laterally along a thin strip at the leading edge of the label sheet. The leading edge strip defines the feeding direction for the sheet and its orientation so that various information may be printed atop the various labels of the label sheet in the same configuration as multiple sheets are fed through a printer, such as a typical laser printer. In an initial prototype, the various labels contained full perimeter die cuts to ensure the individual removal thereof when desired. The individual labels must be readily removable without delay or damage to maximize the efficiency of label application to their containers.

It has been known to provide labels for duplex printing, i.e., printing on two sides by passing the media through the rollers, toner and fuser assembly twice. However, the additional heating by two runs through the fuser and the extra manipulation of the media needed to turn it around and run it through the printer process again exacerbated the delamination problem and the problem of adhesive coming off the media into the printer.

### SUMMARY OF THE INVENTION

The inventors have discovered that, when pressure sensitive adhesive labels are used for duplexing applications, they are subject to move roller passes, e.g. de-curl bars, and to more heat than in simplex applications. For instance, prior to passing the de-curl station, the substrate passes through the fuser assembly which melts the toner for anchorage to the substrate. The heat indiscriminately softens the adhesive. This softening together with the stress applied as the substrate is manipulated at an acute angle throughout the printer, duplex unit, and de-curl station causes separation of labels at the die cuts and leakage of the adhesive to the surface. This separation exposes the adhesive to various parts in the printer path. This causes adhesive build-up in the printer and eventual undesired jamming, misfeeds and skewing. Such problems often put the machine out of service requiring attention by a trained service person. It can also damage the fuser assembly and duplex unit.

To avoid these disadvantages, the inventors have discovered that duplexing is improved by tying the die-cut pressure sensitive labels together, and/or to; edges, matrix, waste strips etc., of the media. Tying the individual labels retains them in juxtaposition from separating. The material therefore travels through the de-curl unit with labels intact and little or no leakage of adhesive into the printer. The ties can be strategically placed to fall directly in line with drive rollers within the printer. In order to improve the feed performance of die cut materials within a duplexing operation, during the die cutting process, a “tie” is added in one or more places to link the several die-cut shapes together. Creating a void or dull place within the cutting surface of the die is a preferred way to create a tie. The die cuts as it is designed, except in the void area, thus leaving an uncut section. The uncut section is the tie which continues to attach the individual die-cut sections. Ties prevent the die-cut sections from pulling apart and exposing adhesive within the printer.

According to the invention, the pressure sensitive label sheets, whether of the pharmacy script configuration described above, some other pharmacy script configuration or some other label application, are subject to duplex printing. As described above, the labels are accordingly provided with ties between the labels and other labels, the edges of the sheet, a matrix area, a waste area, etc., of the sheet. The ties are preferably provided by leaving a small area defining the tie not die cut. One or more ties can be provided for a particular label. In one embodiment, multiple ties are provided symmetrically spaced around the label. In another embodiment, one or more ties are provided only at the leading and trailing edges of the label, in terms of the direction of the sheet passing through the printer. In another embodiment, ties are strategically placed to coincide with where the drive rollers of the printer contact the sheet in order to provide additional stability where this friction occurs.

As described above, the invention is particularly useful when the adhesive used in connection with the labels is prone to softening when subject to the heat from the fuser in the printer, for example, at about 400-500° F. The ties keep the label in place, particularly as the sheet is subject to an acute angle to facilitate duplexing, so as to prevent the softened adhesive from leaking off the sheet onto the printer parts. However, the invention can also be applied in applications where the adhesive would not soften in the printer operation, e.g., in cold fuser assemblies or where non-melting adhesives are used. This is because the ties are useful also for preventing delamination which may occur due to the acute angle the sheet is subject to during duplexing.

The laser printers useful in connection with the tied labels of the invention include those known in the art and commercially available, including duplex printers manufactured by LexMark International, Lexington, Ky. The construction and operation of duplex printers are known in the art and need not be described here further.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is a top view of a label sheet configured in accordance with an exemplary embodiment of the present invention for travel through the laser printer.

FIG. 2 is an enlarged, elevational sectional view through the forward portion of the label sheet illustrated in FIG. 1 and taken generally along line 4-4 positioned below a pickup roller of the printer.

### EXAMPLES

In the foregoing and in the following examples, all temperatures are set forth uncorrected in degrees Celsius, and unless otherwise indicated, all parts and percentages are by weight.

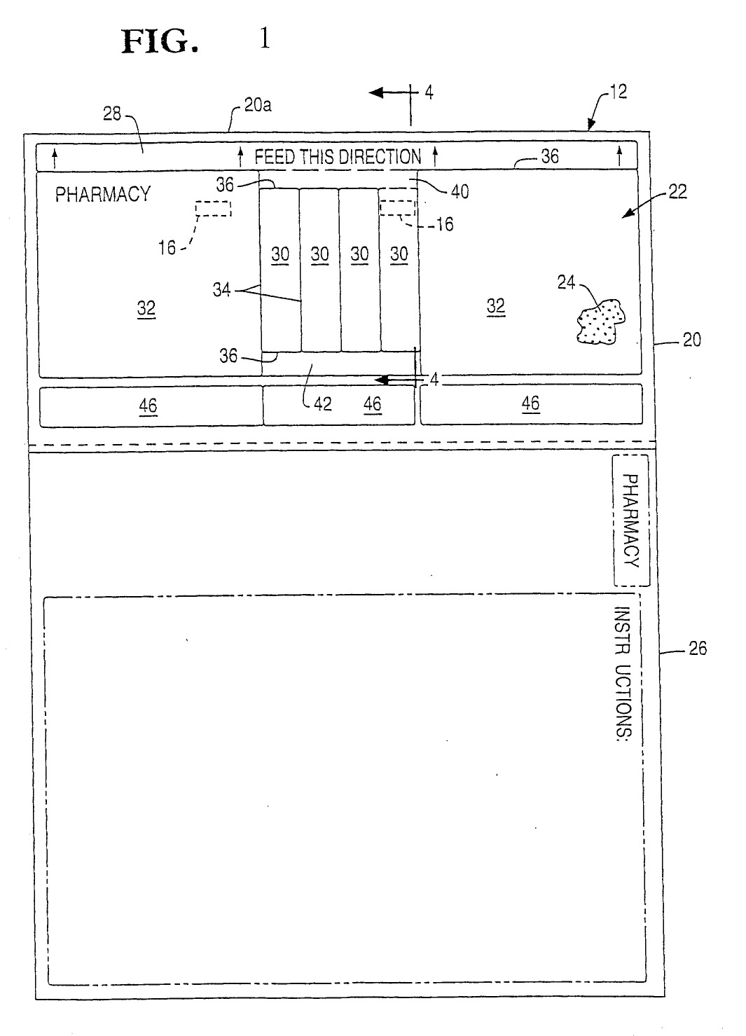

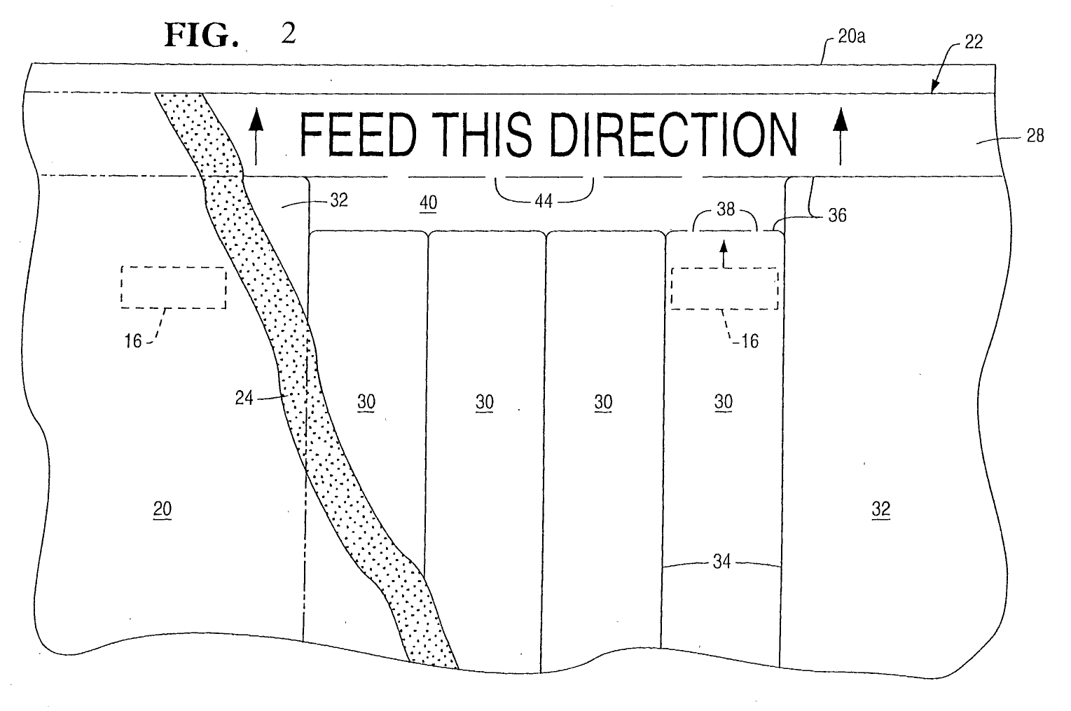

An exemplary one of the label sheets of the invention is illustrated in FIG. 1 in front view in the form a specifically configured pharmacy script. The forward end of the label sheet is illustrated in more detail in FIG. 2.

The label sheet includes a release liner 20 which may have any conventional configuration and composition, and typically includes a silicone coated material having low adhesion capability. The liner 20 supports a face sheet or overlay 22 which is adhesively bonded thereto using a suitable adhesive 24 such as that typically used for pressure sensitive labels.

In the exemplary embodiment illustrated in FIG. 1, the label sheet 12 also includes an integrated paper form sheet 26 bonded to the liner 20 at a lap joint therebetween extending the full width of the sheet. The form sheet 26 may be configured for any useful purpose such as containing various printed information thereon for use in conducting a typical pharmaceutical prescription drug transaction.

Pharmacy scripts have enjoyed years of commercial use in the United States, and have various conventional constructions and configurations, with multiple pressure sensitive labels attached to a liner integrated with an attached form sheet. More specifically, the release liner 20 illustrated in FIG. 1 has a leading edge 20a which first travels through the corresponding path inside the printer 10 illustrated in FIGS. 1 and 2. As used herein, leading edges are those edges which first travel along the feed path through the printer, with trailing edges being opposite edges along the travel or feed direction which last follow the corresponding leading edges through the printer.

With respect to FIG. 1, the liner leading edge 20a is disposed at the vertical top of the sheet and extends the full lateral or horizontal width therebetween. The trailing edge of the liner 20 overlaps and is suitably bonded to the leading edge of the form sheet 26, also along the entire width of the script. And, the form sheet 26 has a horizontal trailing edge which is disposed at the vertical bottom of the script.

The left and right side edges of the script extend vertically over its length, and define horizontally therebetween the width of the script. The script in the exemplary embodiment illustrated is rectangular, and is longer in length or height than it is wide. The exemplary rectangular script is 8.5 by 14 inches (21.6 cm by 35.6 cm) in height and width, respectively.

The label sheet includes a thin feed strip 28 which extends laterally across the liner 20 adjacent the leading edge 20a thereof. The thin feed strip 28 has a thickness or height of about 5 mm and extends substantially the full width of the liner. The feed strip 28, itself, has a leading edge slightly offset back from the leading edge of the liner by about 1 mm, for example, and also has a trailing edge.

The overlay 22 in the preferred embodiment illustrated in FIG. 3 has a plurality of laterally narrow labels 30 laterally adjoining each other, and which are laterally straddled by a pair of wide labels 32 extending laterally to the opposite left and right sides of the liner. The narrow labels 30 are about 12 mm wide, and relatively narrow compared to the wider labels 32 which are about 90 mm in width, for example. The narrow labels 30 are about 41 mm in length or height, as compared to the larger wide labels 32 which are 50 mm in height, for example.

Both the narrow and wide labels 30,32 laterally adjoin each other in turn along the length of the feed strip 28 over substantially the entire width of the liner. The feed strip and the labels are defined and severed from each other by corresponding die cuts including vertical die cuts 34 and horizontal die cuts 36. The die cuts 34,36 are conventionally formed using a sharp die blade which severs the overlay 22 down to but not including the underlying liner 22. The die cuts permit the individual removal of the labels from the liner by being peeled away therefrom, without adjoining labels being carried therewith. Each label must be separately removed for subsequent reattachment to another surface as desired using the same adhesive 24 coating the back sides thereof.

FIG. 2 illustrates an enlarged view of the top center of the label sheet illustrated in FIG. 1. In the exemplary embodiment illustrated, there are four laterally adjoining narrow labels 30 straddled between the end two wide labels 32. The wide labels may be printed by the printer with any useful information regarding a typical prescription drug transaction such as an identification of the prescription and customer, and use instructions, with the labels being manually peeled from the liner 20 individually for reattachment around a prescription container (not shown) or packaging box. The four narrow labels 30 may have printed thereon additional information such as various warnings or use instructions, with each narrow label being individually removable for placement around the prescription container or its box.

The specific configuration of the pharmacy script illustrated in FIGS. 1 and 2 is controlled by its specific intended use. The script is a specialty configuration, having specially configured labels and form sheet. As a result thereof, the feed strip 28 contains a legend stating “FEED THIS DIRECTION” and corresponding arrows which point vertically upwardly along the height of the strip for ensuring the proper feeding of the script in the laser printer 10. The printer is software controlled by a corresponding computer which includes all the desired information being printed atop the script during a transaction.

The entire disclosure of all applications, patents and publications, cited above is hereby incorporated by reference.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A label sheet for duplex printing which comprises a face sheet, an adhesive layer bonded to the face sheet and a release liner removably adhered to the adhesive, having:
two printable sides of the sheet,
at least one removably adhered label defining an area on the surface of at least one side of the face sheet, and
a tie tying the label to another area on the same surface of the face sheet.

2. A label sheet of claim 1, wherein the label is provided with at least one tie on a leading edge of the label and at least one tie on a trailing edge of the label, the leading and trailing edges being defined by the direction the label sheet would pass through a printer.

3. A label sheet of claim 2, wherein the label has multiple ties on the leading and trailing edges, evenly spaced from one another.

4. A label sheet of claim 2, wherein ties are provided on the leading and trailing edges so as to correspond to where the drive rollers of the duplex printer contact the sheet.

5. A label sheet of claim 1, wherein the label is defined by a die cut through the face sheet to the adhesive around the perimeter of the label and the tie(s) are defined by portions around the perimeter of the label which are not die cut.

6. A label sheet of claim 1, wherein the label sheet comprises two face sheets and two adhesive layers, one each on each side of the release liner.

7. A label sheet of claim 6, which comprises at least one label on each side of the sheet.

8. A label sheet of claim 1, wherein the label sheet comprises multiple labels on at least one face sheet and each label is provided with at least one tie to another label, to an edge of the face sheet around its perimeter and/or to a matrix of the face sheet separating the labels from one another.

9. A label sheet of claim 1, wherein the adhesive layer is comprised of an adhesive which softens at temperatures to which it is subject during duplex printing with fusion of the toner by heating.

10. A label sheet of claim 9, wherein the adhesive softens at a temperature from 400 to 500° F.

11. A method for duplex printing a label sheet which comprises feeding a label sheet according to claim 1 through a duplex printer where the duplex printed includes an operation where the label sheet is turned over a roller at an acute angle.

12. A method of claim 11, which includes an operation where the label sheet is subject to heating to fuse toner to the sheet.

13. A method of claim 12, wherein the heating is at 400 to 500° F.

14. A method of claim 11, wherein the labels on the label sheet are provided with ties where driver rollers of the duplex printer contact the sheet.

15. A method of claim 11, wherein the labels of the label sheet are provided with at least one tie on a leading edge of the label and at least one tie on a trailing edge of the label, the leading and trailing edges being defined by the direction the label sheet would pass through the printer.

16. A method of claim 15, wherein the labels have multiple ties on the leading and trailing edges, evenly spaced from one another.
